(19) United States
(12) Patent Application Publication
(10) Pub. No.: US 2008/0294457 A1
(43) Pub. Date: Nov. 27, 2008

(54) Real-time medical records

(76) Inventors: Robert A. Cordery, Danbury, CT (US); Easwaran Nambudiri, Rye Brook, NY (US); Andrei Obrea, Seymour, CT (US); Frederick W. Ryan, JR., Oxford, CT (US); Benjamin D. Singer, Chicago, IL (US); John W. Sussmeier, Cold Spring, NY (US)

Correspondence Address: PITNEY BOWES INC.;35 WATERVIEW DRIVE, P.O. BOX 3000, MSC 26-22, SHELTON, CT, 06484-8000, US

(21) Appl. No.: 11/805,923

(22) Filed: May 25, 2007

(51) Int. Cl. G06Q 50/00; G04G 15/00

(52) U.S. Cl. 705/2; 702/177

(57) ABSTRACT

According to some embodiments, a system and a method are provided to receive a real-time medical entry from a medical professional where the medical entry comprises one or more medical terms, to automatically compare the one or more medical terms with a plurality of data records, each data record associated with a billing code, and to select a coding term if one of the one or more medical terms matches the plurality of data records.

### BACKGROUND

Hospitals generate revenue by billing patients, insurance companies, and government entities for services performed. For example, a patient suffering from an illness may be admitted to a hospital for testing such as blood tests, heart monitoring and/or other diagnostic tests. Each test or procedure may be associated with a specific billing code and a specific cost.

A doctor or other medical professional that administers a test on a patient, might write down each test on the patient's chart and, when the patient is discharged, the data contained on the chart may be converted into a plurality of billing codes to construct a patient bill. If a delay should occur between a time when a patient is discharged and a time when a chart is coded, a possibility exists that either the doctor may have a memory lapse and some information may not be coded or there may be some confusion as to what test or procedure was performed. The coding process itself may be labor-intensive, and typically includes clerical employees known as “coders” who review a patient's chart after discharge and translate the types of treatment performed into billing codes.

### SUMMARY

In one embodiment, a method is directed to receiving a real-time medical entry from a medical professional where the medical entry comprises one or more medical terms. The method is further directed to automatically comparing the one or more medical terms with a plurality of data records, each data record associated with a billing code, and selecting a coding term if one of the one or more medical terms matches the plurality of data records. In some embodiments, if a determination is made that one of the one or more medical terms does not match the plurality of data records or that one of the one or more medical terms matches two or more data records then one or more substitute terms each associated with a billing code may be provided to the medical professional.

A system is also disclosed. The system may include a digital pen, a database, and a coding system server. The digital pen may comprise an alerting mechanism and a digital pen display. The database is used to store data such as billing codes. The coding system server is to receive a real-time medical entry comprising one or more medical terms from the digital pen and is to automatically compare the one or more medical terms with a plurality of data records, each associated with a billing code. Moreover, the coding server is to select a coding term if one of the one or more medical terms matches one of the plurality of data records.

In some embodiments, a method is directed to writing a medical entry via a digital pen, the medical entry comprising one or more medical terms. The method further describes receiving a notification via the digital pen, receiving one or more substitute terms each associated with a billing code, and sending an indication via the digital pen to replace one of the one or more medical terms with one of the one or more substitute terms.

Therefore, it should now be apparent that the invention substantially achieves all the above aspects and advantages. Additional aspects and advantages of the invention will be set forth in the description that follows, and in part will be obvious from the description, or may be learned by practice of the invention. Various features and embodiments are further described in the following figures, descriptions, and claims.

### BRIEF DESCRIPTION OF THE DRAWINGS

The accompanying drawings illustrate presently preferred embodiments of the invention and, together with the general description given above and the detailed description given below, serve to explain the principles of the invention. As shown throughout the drawings, like reference numerals designate like or corresponding parts.

FIG. 1 illustrates a method according to some embodiments.

FIG. 2 illustrates a system according to some embodiments.

FIG. 3 illustrates a digital pen according to some embodiments.

FIG. 4 illustrates a method according to some embodiments.

FIG. 5 illustrates a method according to some embodiments.

### DETAILED DESCRIPTION

The several embodiments described herein are provided solely for the purpose of illustration. Embodiments may include any currently or hereafter-known versions of the elements described herein. Therefore, persons in the art will recognize from this description that other embodiments may be practiced with various modifications and alterations.

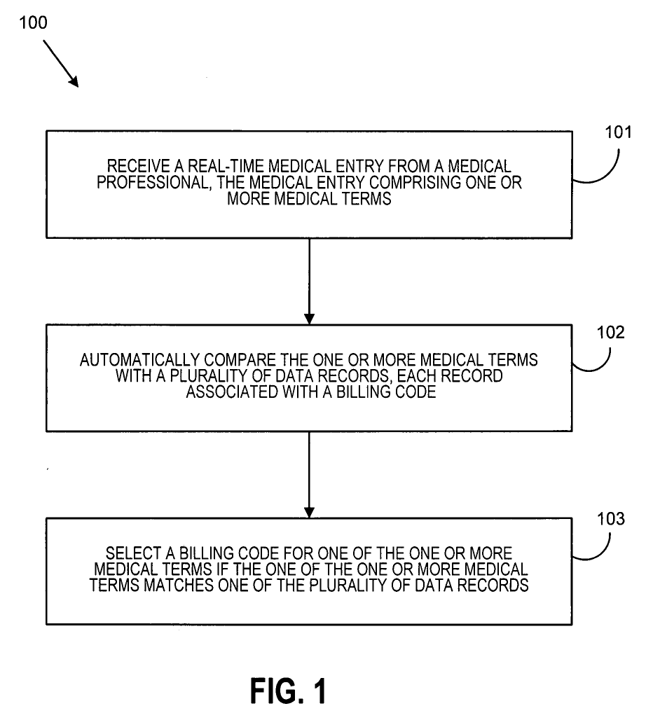

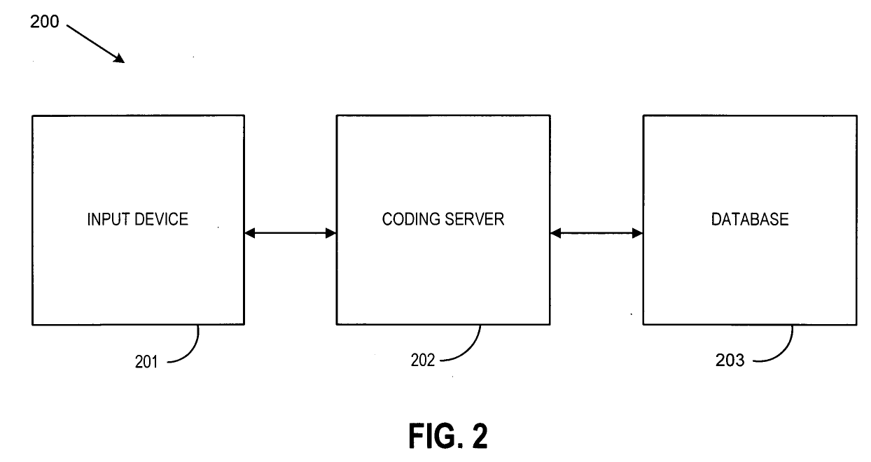

Now referring to FIG. 1, an embodiment of a method 100 is illustrated. The method 100 may be executed by any combination of hardware, software, and firmware, including but not limited to, the system 200 of FIG. 2. At 101, a real-time medical entry is received from a medical professional, the medical entry comprising one or more medical terms. In some embodiments, a medical professional may be, but is not limited to, a doctor, a nurse, or a medical technician. A medical entry may be any notation, indication, or record associated with a patient. In some embodiments, the entry may be received by a system via a wireless network, a local area network, a wide area network, or a metropolitan area network. The entry may be received by a server computer that automatically generates billing codes from medial entries.

For illustrative purposes, and to aid in understanding features of the invention, an example will now be introduced. This example will be carried through the detailed description and this example is not intended to limit the scope of the invention.

A doctor may indicate on a patient's chart, as a medical entry, that the patient requires a specific procedure or diagnostic test, such as, but not limited to, a blood test, an x-ray and/or a toxicology screening. The medical entry may comprise one or more medical terms. For example, a medical entry for a blood test may indicate a plurality of specific tests to run on the patient's blood.

After an entry is received, the one or more medical terms may be automatically compared by a billing server with a plurality of data records, each data record associated with a plurality of billing codes, as illustrated at 102. A data record may comprise one or more searchable fields, each field comprising data associated with a billing code. In some embodiments, a system, such as the later described system of FIG. 2, may automatically compare the one or more medical terms with the plurality of data records.

Continuing with the blood test example, each specific test may have a specific name and each test may be compared to a plurality of known tests to determine a billing code associated with that test.

Next, at 103, a billing code is selected for one of the one or more medical terms if the one of the one or more medical terms matches one of the plurality of data records.

For example, and continuing with the above blood test example, if a specific name of a test matches a single data record associated with a billing codes, then the matched billing code is selected for the named test. The matched billing code may then be used to construct a patient's bill.

Now referring to FIG. 2, an embodiment of a system 200 is illustrated. The system 200 may comprise an input device 201, a coding server 202, and a database 203. The input device 201 may communicate with the coding server 202 and may transmit a medical entry to the coding server in real-time as a medical professional writes the medical entry. In one embodiment, the input device 201 may be, but is not limited to, a digital pen, such as an Anoto Group AB digital pen. In some embodiments, the input device 201 may be a voice input device, a personal data assistant, a tablet, or any device that may create a medical entry. In some embodiments, the input device 201 may communicate via a wireless technology, such as, but not limited to, Bluetooth or an IEEE 802.11-based network.

The database 203 may comprise any database that is, or becomes known. In some embodiments, database 203 may store a plurality of data records and may comprise a first database that stores medical records and a second database that stores coding information. The coding database, for example, may contain billing codes, associated terms and synonyms, and phrases of medical significance.

The coding server 202 may automatically compare the one or more medical terms received from the input device 201 with a plurality of data records stored in the database 203, each data record associated with a billing code. If one of the one or more medical terms matches one of the plurality of data records stored in the database 203, then a coding term may be selected for a patient's bill.

The coding server 202 may comprise memory, a computer readable medium to store instructions, and a processor. The coding server 202 may send and receive data from the input device 201. The instructions stored on the computer readable medium may be executed by the processor to perform a method. The method may comprise, but is not limited to, the method of FIG. 1. In one embodiment, the coding server 202 comprises a wireless communications unit to communicate with the input device 201. In another embodiment, the input device may communicate wirelessly with a personal computer (not separately shown) that is located in the same room with the input device. The personal computer may relay communications between the input device and the coding server.

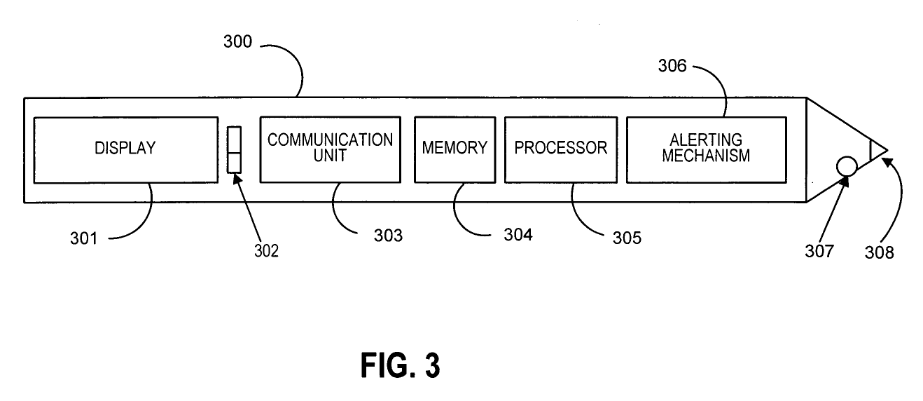

Now referring to FIG. 3, an embodiment of a digital pen 300 is illustrated. The digital pen 300 may comprise a display 301, a selector switch 302, a communication unit 303, memory 304, a processor 305, an alerting mechanism 306, a camera 307, and an ink tip 308. The ink tip 308 may be used for conventional writing and the camera 307 may scan or record an image of the writing in real-time.

The display 301 may be any screen or display, such as, but not limited to, a liquid crystal diode display. The selector switch 302 may allow a user to scroll through data presented on the display 301 and select specific data for transmission to the coding server 202. In one embodiment, an indication of selected data is transmitted to the coding server 202. For example, if three specific blood tests, each associated with a specific billing code, are displayed on the display 301, then the billing code associated with the specific blood test selected may be transmitted to the coding server 202.

The communication unit 303 may transmit selected data to and receive responses from the coding server 202. The communication unit 303 may communicate via a wireless technology, such as, but not limited to, Bluetooth or an IEEE 802.11-based network.

The memory 304 may store, for example, applications, programs, procedures, and/or modules that store instructions to be executed. The memory 304 may comprise, according to some embodiments, any type of memory for storing data, such as a Single Data Rate Random Access Memory (SDR-RAM), a Double Data Rate Random Access Memory (DDR-RAM), or a Programmable Read Only Memory (PROM). The processor 305 may be any processor that is, or becomes known.

In some embodiments, the alerting mechanism 306 may be, but is not limited to, a vibrator or one or more light emitting diodes (“LED”). In one embodiment, the alerting mechanism 306 may vibrate to alert a medical professional that the display 301 contains information requiring a response, and, in another embodiment, the alerting mechanism 306 may repeatedly flash to alert a medical professional that the display 301 contains information requiring a response.

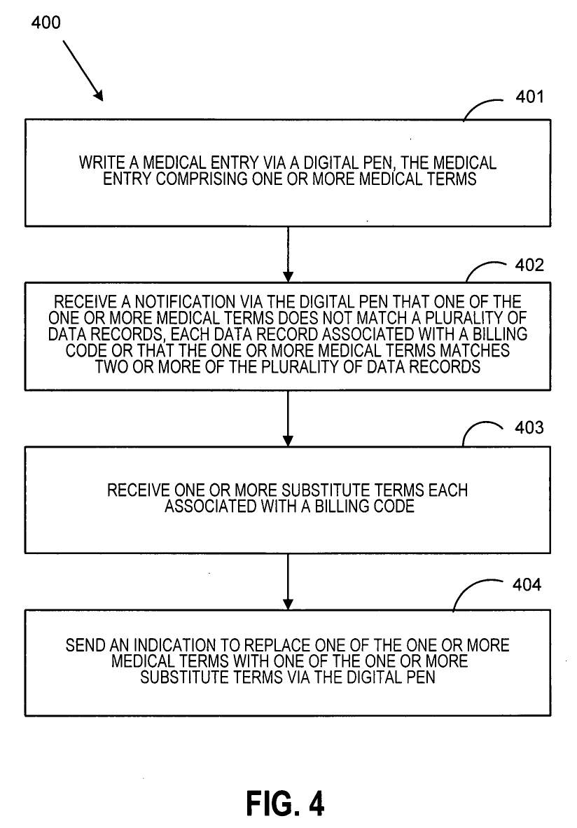

FIG. 4 illustrates an embodiment of a method 400. At 401 a medical entry is written via a digital pen, the medical entry comprising one or more medical terms. Using the above blood test example, a doctor may, for example, request a series of blood tests for a patient by writing down the requests as an entry on the patient's chart. As is conventional with the above-mentioned Anoto pen, the chart may be formed from paper printed with a special pattern of dots. The pattern of dots may be detected by the digital pen to trace the movement of the digital pen across the paper. The digital pen may translate its movement into handwritten letters and may further translate the handwritten letters into text. The text may be transmitted to the coding server, directly or indirectly, as a medical entry. Next, at 402, a notification is received via the digital pen that one of the one or more medical terms does not match a plurality of data records, each data record associated with a billing code or a notification is received that one of the one or more medical terms matches two or more of the plurality of data records. An alerting mechanism may inform a holder of the digital pen that notification should be viewed. At 403, one or more substitute terms, each associated with a billing code, are received.

For example, and using the above blood test example, one of the requested blood tests written on the chart may have been misspelled or the name of the requested blood test may be ambiguous and thus may be associated with two different blood tests. To solve the aforementioned problem, a notification may be sent to the doctor to cure the misspelling or ambiguity by selecting a substitute blood test. Allowing medical professionals to correct medical entry misspellings and ambiguities in real time may improve billing efficiency.

Next, at 404, an indication to replace one of the one or more medical terms with one of the one or more substitute terms is provided to the doctor via the digital pen. The doctor may be alerted via an alerting mechanism to view the indication on a display. In some embodiments, the doctor may be alerted through a nearby computer. For example, and using the above blood test example, the doctor may select a substitute test that corresponds to the requested blood test by selecting that test via the digital pen selector switch 302. In response to the selecting, an indication of the substitute test may be sent from the digital pen to the coding server 202.

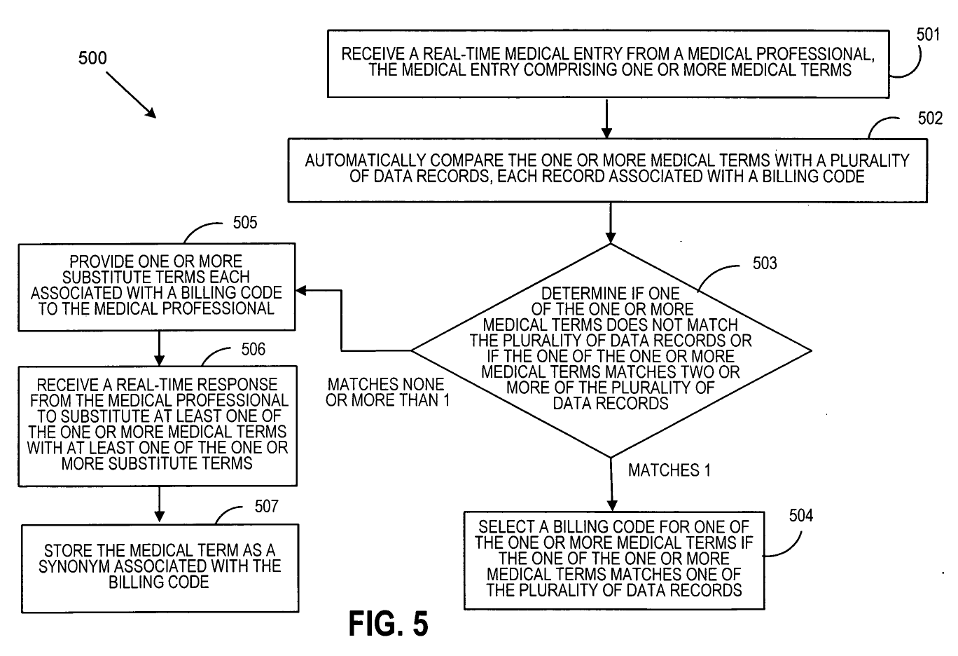

Now referring to FIG. 5, an embodiment of a method 500 is illustrated. The method 500 may be executed by any combination of hardware, software, and firmware, including but not limited to, the system 200 of FIG. 2. At 501, a real-time medical entry is received from a medical professional, the medical entry comprising one or more medical terms. In some embodiments, the real-time entry may be received via the coding server 202. After an entry is received, the one or more medical terms may be automatically compared with a plurality of data records stored in database 203, each data record associated with a billing code, as illustrated at 502. In one embodiment, a system, such as system 200 of FIG. 2, may automatically compare the one or more medical terms with the plurality of data records. In one embodiment, a human coder may compare the one or more medical terms with the plurality of data records.

At 503, a determination is made if one of the one or more medical terms does not match the plurality of data records or if the one of the one or more medical terms matches two or more of the plurality of data records. In one embodiment, a human coder determines that one of the one or more medical terms does not match the plurality of data records and in another embodiment, a computer system determines that one of the one or more medical terms does not match the plurality of data records.

If the one of the one or more medical terms matches one of the plurality of data records then one of the one or more medical terms is selected at 504 and a corresponding billing code is selected by the human coder or the coding server, as the case may be. However, if one of the one or more medical terms does not match the plurality of data records or if the one of the one or more medical terms matches two or more of the plurality of data records then, at 505, one or more substitute terms each associated with a billing code are provided to the medical professional. In a case where the medical term is misspelled, the substitute term may also be an alternate term. The substitute terms may also be sent with information helpful in clarifying the substitute term. In one embodiment, the one or more substitute terms are provided to a medical professional via the digital pen display. In one embodiment, the one or more substitute terms are provided to a medical professional via a standalone display.

For example, and continuing with the above blood test example, if a specific name of one of a plurality of blood tests requested does not match data records with one of the plurality of billing codes, then one or more substitute blood test names may be selected and provided to the medical professional. The substitute names may be provided to the medical professional by sending the one or more of substitute names to a digital pen display 301 and a notification may be sent to the medical professional via the alerting mechanism 306 of the digital pen to alert the medical professional to view the display. The indication may comprise vibrating the pen by activating a vibrator within the digital pen or by lighting one or more LEDs. In one embodiment the LEDs may flash on and off.

Next, at 506, a real-time response from the medical professional to replace at least one of the one or more medical terms with at least one of the one or more substitute terms is received. In some embodiments, the real time response may be to use the initially received term and that the initially received term will be reconciled at a later date. In some embodiments, the response may be that the medical professional requires a meeting or communication with a coder to review the term change. In some embodiments, the response may be a request for more information. Continuing with the above blood test example, the medical professional may select a substitute term on the display screen via a selector switch and transmit that substitute term to the coding server.

At 507, the medical term is stored as a synonym associated with the billing code. In one embodiment, the synonym is stored in a database. The database may also store information about the date, time and location of the entry, personal information about the patient, diagnoses and supporting test results, orders for further tests, and prescriptions for treatments or medicines. For example, a medical entry may contain a request for blood text X but blood test X is not contained in any data fields in the plurality of data records. However, the data fields contain blood test W and blood test Y. If a doctor selects blood test Y as a substitute for blood test X, then blood test X may be stored as a synonym for blood test Y in the database. In some embodiments, the synonyms may be doctor specific.

A number of embodiments of the present invention have been described. Nevertheless, it will be understood that various modifications may be made without departing from the spirit and scope of the invention. Other variations relating to implementation of the functions described herein can also be implemented. Accordingly, other embodiments are within the scope of the following claims.

What is claimed is:

1. A method comprising:
receiving a real-time medical entry from a medical professional, the medical entry comprising one or more medical terms;
automatically comparing the one or more medical terms with a plurality of data records, each data record associated with a billing code; and
selecting a billing code for one of the one or more medical terms if the one of the one or more medical terms matches one of the plurality of data records.

2. The method of claim 1, further comprising:
determining that one of the one or more medical terms does not match the plurality of data records or that one of the one or more medical terms matches two or more of the plurality of data records; and
providing one or more substitute terms each associated with a billing code to the medical professional.

3. The method of claim 2, wherein the one or more substitute terms are alternate terms.

4. The method of claim 2, further comprising:
receiving a real-time response from the medical professional to substitute at least one of the one or more medical terms with at least one of the one or more substitute terms; and
storing the medical term as a synonym associated with a billing code.

5. The method of claim 2, wherein a computer system determines that one of the one or more medical terms does not match the plurality of data records or that one of the one or more medical terms matches two or more of the plurality of data records.

6. The method of claim 1, wherein the real-time medical entry is entered via a digital pen.

7. The method of claim 6, wherein the digital pen comprises:
an alerting mechanism; and
a digital pen display.

8. The method of claim 7, wherein the alerting mechanism comprises a vibrator or a light emitting diode.

9. The method of claim 7, wherein the one or more substitute terms are provided to the medical professional via the digital pen display.

10. The method of claim 7, further comprising:
providing an indication to the medical professional via the alerting mechanism.

11. A system comprising:
an input device comprising an alerting mechanism and a display, wherein the input device comprises at least one of a digital pen, a tablet, or a personal data assistant;
a database to store billing codes; and
a coding system server to:
receive a real-time medical entry from the input device, the medical entry comprising one or more medical terms;
automatically compare the one or more medical terms with a plurality of data records, each data record associated with a billing code; and
select a billing code for each of the one or more medical terms if each of the one or more medical terms matches one of the plurality of data records.

12. The system of claim 11, wherein the coding system server is to:
determine that one of the one or more medical terms does not match the plurality of data records or that one of the one or more medical terms matches two or more data records;
provide an indication via the alerting mechanism; and
provide one or more substitute terms each associated with a billing code to the input device.

13. The system of claim 12, wherein the one or more substitute terms each associated with a billing code are matched billing codes.

14. The system of claim 12, wherein the one or more substitute terms each associated with a billing code are alternative billing codes.

15. The system of claim 11, wherein the alerting mechanism comprises a vibrator or a light emitting diode.

16. The system of claim 11, wherein the one or more substitute terms each associated with a billing code are provided to a medical professional via the display.

17. A method comprising:
writing a medical entry via a digital pen, the medical entry comprising one or more medical terms;
receiving a notification via the digital pen that one of the one or more medical terms does not match a plurality of data records, each data record associated with a billing code or that the one or more medical terms matches two or more of the plurality of data records;
receiving one or more substitute terms each associated with a billing code; and
sending an indication to replace one of the one or more medical terms with one of the one or more substitute terms via the digital pen.

18. The method of claim 17, wherein the digital pen comprises:
an alerting mechanism; and
a digital pen display.

19. The method of claim 18, wherein the alerting mechanism comprises a vibrator.

20. The method of claim 18, wherein the one or more substitute terms are displayed via the digital pen display.
